(19) United States
(12) Patent Application Publication
(10) Pub. No.: US 2026/0205392 A1
(43) Pub. Date: Jul. 16, 2026

(54) NFC-ENABLED CONFIGURATION AND DIAGNOSTIC TECHNOLOGIES OF DEVICES

(71) Applicant: Dell Products L.P., Round Rock, TX (US)

(72) Inventor: Anton Rang, Houlton, WI (US)

(21) Appl. No.: 19/025,990

(22) Filed: Jan. 16, 2025

(51) Int. Cl. H04L 43/0817; H04L 41/082; H04L 67/1097

(52) U.S. Cl. CPC H04L 43/0817; H04L 41/082; H04L 67/1097

(57) ABSTRACT

A device is provided including a discrete unit in which computer executable components are housed within an outer encasement. The computer executable components may include: an embedded controller configured to interface with operational modules of the device; and a near-field communication (NFC) interface connected with the embedded controller. The embedded controller is configured to: detect, via the NFC interface, a first carrier field generated by a user device, and, in response to detecting the first carrier field, establish, via the NFC interface, a connection between the NFC interface and the user device for bidirectional communication, resulting in an established connection. The embedded controller is further configured to generate, for receipt by the user device via the established connection, a second carrier field communicating data. The device may be configured for use as a computing node or a storage node of the data storage system.

### BACKGROUND

Modern data centers can include anywhere from hundreds to thousands of servers and storage enclosures. The management and servicing of such a large number of devices creates significant challenges. Improved servicing processes that yield even incremental improvements in efficiency often yield comparatively outsized benefits in terms of reducing technician labor, limiting server downtime, and promoting optimal performance. Data centers typically organize servers and storage enclosures, which may be referred to generally as “devices” or “nodes,” in racks or cabinets. Such racks are then arranged in rows to provide technicians with access.

The above-described context with respect to conventional computing systems is merely intended to provide an overview of current technology and is not intended to be exhaustive. Other contextual description, and corresponding benefits of some of the various non-limiting embodiments described herein, will become further apparent upon review of the following detailed description.

### SUMMARY

The following presents a simplified summary of the disclosed subject matter to provide a basic understanding of various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a device is described herein. The device may include a discrete unit in which computer executable components are housed within an outer encasement. The computer executable components may include: an embedded controller configured to interface with operational modules that manage operation of the device and control respective different operational areas of the device; and a near-field communication (NFC) interface connected with the embedded controller that facilitates sending and receiving NFC communications. The embedded controller may be further configured to: detect, via the NFC interface, a first carrier field generated by a user device; in response to detecting the first carrier field, establish, via the NFC interface, a connection between the NFC interface and the user device for bidirectional communication, resulting in an established connection; and generate, for receipt by the user device via the established connection, a second carrier field communicating data. The device may be configured for use as a computing node of a data storage system or a storage node of the data storage system.

In an example embodiment, a method is described herein. The method may include: configuring, by a system comprising at least one processor, a network-attached storage (NAS) system comprising devices, wherein each device of the devices comprises one of a respective computing node or a respective storage node. The configuring may include: detecting, via a near-field communication (NFC) interface embedded in a selected device of the devices, a first carrier field generated by a user device; in response to detecting the first carrier field, establishing, via the NFC interface of the selected device, a connection between the NFC interface and the user device for bidirectional communication, resulting in an established connection; generating, for receipt by the user device via the established connection, a second carrier field communicating menu data usable by the user device to construct a user interface that displays selectable configuration settings that govern respective operating parameters of the NAS system; and receiving, from the user device via the established connection, a third carrier field communicating command data describing a command to adjust a configuration setting of the selectable configuration settings.

In an example embodiment, a method is described herein. The method may include: integrating, by a system comprising at least one processor, a device into a network-attached storage (NAS) system comprising established devices, wherein the device and the established devices each comprises one of a respective computing node or a respective storage node. The integrating may include: receiving, by an established device of the established devices, an integration token that was previously communicated, via a first near-field communication (NFC) interface embedded in the device, from the device to a user device in a first carrier field using an established connection between the first NFC interface and the user device for bidirectional communication. The established connection was established, via the first NFC interface, in response to detection, via the first NFC interface, of a second carrier field that was generated by the user device prior to the integration token being previously communicated from the device. The receiving may include: detecting, via a second NFC interface embedded in the established device, a third carrier field generated by the user device; in response to detecting the third carrier field, establishing, via the second NFC interface of the established device, a connection with the user device for bidirectional NFC communication between the established device and the user device, resulting in an established connection; and receiving, by the second NFC interface of the established device from the user device using the established connection, an NFC communication comprising the integration token. In response to receiving the integration token, the integrating may further include initiating an integration process for integration of the device into the NAS system based on information contained within the integration token.

To the accomplishment of the foregoing and related ends, the disclosed subject matter includes one or more of the features hereinafter more fully described. The following description and the annexed drawings set forth in detail certain illustrative example embodiments of the subject matter. However, these example embodiments are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Features and advantages of the present technique will become more apparent from the following detailed description of exemplary embodiments thereof taken in conjunction with the accompanying drawings in which:

FIG. 1 illustrates an example system for implementing near-field communications with one or more nodes according to various example embodiments;

FIG. 2 illustrates the front panel of a server with a near-field communication (NFC) interface according to various example embodiments;

FIG. 3 is a schematic diagram of a server with NFC interface according to various example embodiments;

FIG. 4 illustrates the front panel of a storage enclosure with an NFC interface according to various example embodiments;

FIG. 5 is a schematic diagram of a storage enclosure with NFC interface according to various example embodiments;

FIG. 6 is a schematic diagram illustrating NFC communication between a node having an NFC interface and a user device according to various example embodiments;

FIG. 7 illustrates a method for retrieving data from a device using near-field communication according to various example embodiments;

FIG. 8 illustrates a method for retrieving data from or configuring a device using near-field communication according to various example embodiments;

FIG. 9 illustrates a method for integrating a device into a network using near-field communication according to various example embodiments;

FIG. 10 illustrates a method for configuring a network having devices using near-field communication according to various example embodiments; and

FIG. 11 is an example of an embodiment of a computer system that may utilize the techniques described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments. Like reference numerals have been used to illustrate like components across the figures.

The process of providing maintenance and service to the vast number of devices, e.g., servers and storage enclosures, housed within modern data centers places a high premium on efficiency. Servicing processes that yield improvements in efficiency can result in considerable cost reductions and performance improvements. The present application pertains to a system for providing diagnostics and configuration to servers and/or storage enclosures of data centers, which may be referred to herein generally as “devices” or “nodes,” via near-field communication (NFC) technology. In this regard, servers and storage enclosures (as mentioned, also referred to as devices or nodes) are typically included in racks or cabinets. Such racks are then arranged in rows to provide technicians with access. However, the process of servicing such components remains overly time-consuming, typically involving a technician to physically connect a user device with each device before diagnosing or configuring it. While example limited functionality may be achieved via the front panel of a server, most diagnostics or configuration must be done via a cable connected to USB, serial, or network ports, with technicians employing laptops, portable keyboards, and monitors on carts to access and service these systems. This approach is further slowed when access to the rear of a device is implicated, which may be located in a different row than the front panel of the device being serviced. These operational deficiencies can be disruptive to data center operations.

In addressing these and/or other deficiencies of conventional systems, example embodiments of the present application include embedding an NFC interface within a device for enabling wireless communication with an NFC-enabled user device (or NFC user device), such as a smartphone or tablet. According to example embodiments, the NFC interface may be integrated with device firmware so that diagnostic information related to the device can be provided via NFC to the NFC user device. In other embodiments, the device may accept a set of commands via NFC that facilitate various management tasks without the need for a physical connection. In this way, for example, example embodiments may enable a technician to simply hold a user device near a server with an embedded NFC interface and, thereby, read diagnostic codes related to the server and/or send configuration commands to the server. The need for cables and other cumbersome equipment is eliminated, and the efficiency of the servicing process is enhanced.

In general, near-field communication (NFC) encompasses a set of standards for radio frequency communications that enable devices to interact when they are in close proximity. Implementation protocols for NFC adhere to industry standards like ISO/IEC 18092 or ISO/IEC 18000-3, as published by the International Standards Organization. NFC offers several advantages over other wireless protocols and data encoding methods for mobile terminals. The short-range nature of NFC ensures that users of mobile terminals reading an NFC enabled device are in close proximity to the device, preventing cross-talk from other nearby devices. The effective range for NFC is typically around four centimeters. This short range also enhances access and security management, as device owners can limit physical proximity to authorized users only. It allows the NFC device owner to infer the user's intent, making unlikely interactions less probable compared to longer-range protocols. Additionally, NFC's wireless nature can be superior to other data encoding methods like barcodes and quick response (QR) codes, which implicate a visual read and alignment with an image reader. The data rate for NFC is lower compared to other protocols like Bluetooth or WiFi. While other data rates can be used, common NFC data transfer rates are 106, 212, and 424 kbits/s. However, NFC can complement higher-speed protocols for tasks such as device pairing. Additionally, NFC offers low-power wireless communication.

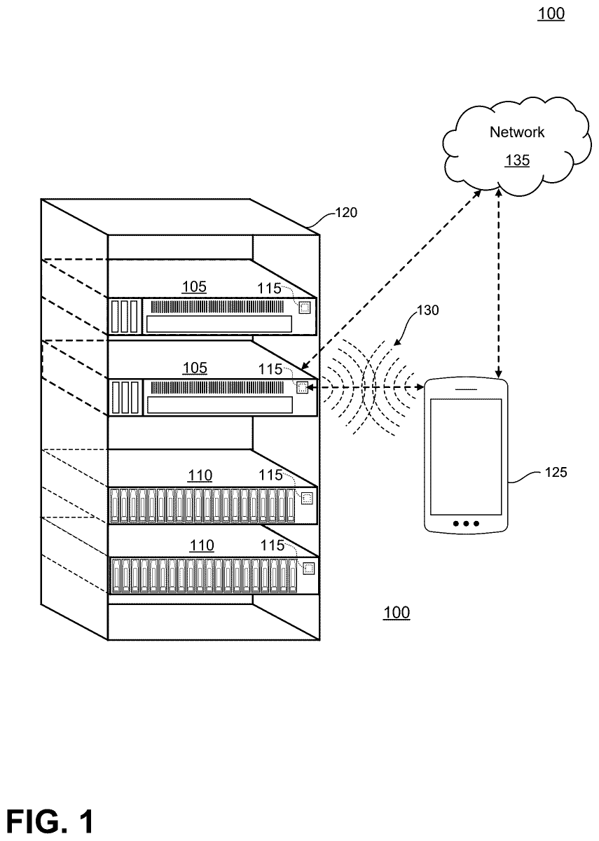

With reference now to FIG. 1, an exemplary embodiment is illustrated that includes a system 100 in which several devices, including servers 105 and storage enclosures 110, are configured with an NFC interface 115 to enable corresponding functionality. The server may be stacked within a device rack 120 to enhance space efficiency. The device rack 120 may include multiple slots, each capable of holding a unit of equipment, such as the illustrated servers 105 or storage enclosures 110. While the device rack 120 is illustrated as having two servers 105 and two storage enclosures 110, more or fewer of each may be present. The device rack 120 may be equipped with cable management systems to organize power and data cables.

The term “device” may be used to generally refer to a network component that either functions as a server, such as the server 105, or a storage enclosure, such as storage enclosure 110. The term “node” may be used in this capacity as well. As used herein, a server is a hardware unit that acts as a computing node within a network, providing processing power, managing network resources, and hosting applications. A server may provide resources or data to other computers, known as clients, over a network. A server may include a Central Processing Unit (CPU), which is responsible for performing computations for executing instructions and running applications. A server may further include an embedded controller for managing the server performance and subsystem operations. On the other hand, a storage enclosure is a hardware unit that acts as a storage node within a network, offering data storage capacity. A storage enclosure may be designed to house multiple storage devices, such as hard drives (HDDs) or solid-state drives (SSDs), that provide scalable data storage. A storage enclosure is typically equipped with drive bays, power supplies, cooling systems, and often includes an embedded controller for managing and monitoring the storage devices. Storage enclosures can connect to servers or networks via high-speed interfaces, enabling data transfer and access. Servers and storage enclosures may facilitate data processing, storage, and retrieval within a network, such as Network-Attached Storage (NAS) systems, Storage Area Networks (SANs), or others.

In accordance with exemplary embodiments, the servers 105 and storage enclosures 110 may be configured to have an NFC enabling interface (or NFC interface) 115 that facilitates communication with an NFC-enabled user device (or user device) 125. The user device 125 may be a smartphone, though other types of user devices, such as a tablet or laptop, may also be used. As illustrated, the exemplary NFC communication in FIG. 1 is occurring between a particular server 105 and a user device 125. While description of exemplary operation will proceed in relation to the particular server 105, it should be understood that the same type of near-field communication may be achieved between the user device 125 and the other NFC-enabled devices, i.e., the other server 105 or either of the storage enclosures 110.

In exemplary embodiments, near-field communication between the NFC interface 115 of an associated device (i.e., the indicated server 105 of FIG. 1) and the user device 125 may be achieved via active or passive modes of operation. In the passive mode, one device, often called the tag, which may be the NFC interface 115, remains passive, meaning it does not generate its own radio frequency or carrier field. Instead, it uses the electromagnetic carrier field generated by the active device to communicate. In the active mode of operation, as shown, both devices generate their own carrier fields 130 and can send and receive data simultaneously, making this mode of operation suitable for tasks that involve bidirectional communication. A peer-to-peer mode may also be supported, where two NFC-enabled devices exchange data by simply bringing them close together. This mode allows for quick and seamless sharing of information without the need for a physical connection. Thus, in example embodiments, the NFC interface 115 may be configured as a passive tag that is encoded with static information relating to the associated device, which can then be transmitted to the NFC user device 125 via NFC. In other embodiments, the NFC interface 115 may also dynamically encode the tag with dynamic information related to the associated device, which can then be transmitted to the user device 125 via NFC. Alternatively, both the NFC interface 115 and the user device 125 may be configured to generate their own carrier fields 130 so that information can be sent and received by each simultaneously. In this way, the NFC interface 115 may provide data to the user device 125 and receive data, such as configuration commands, from the user device 125.

To effectuate such near-field communication, the NFC interface 115 of the associated server 105 and the user device 125 each may include an antenna and related control circuitry, as described more below. Operating in a passive mode, for example, the user device 125, acting as an initiator, may generate a carrier field 130 that a target device, i.e., the NFC interface 115, uses to respond via a modulation of this field. Alternatively, as illustrated in FIG. 1, in an active mode of the communication, the NFC user device 125 and the NFC interface 115 of the server 105 each generates their own carrier fields 130 and communicates by controlling and altering these fields. For example, the user device 125 might feature a loop antenna that magnetically couples with a loop antenna of the NFC interface 115 in the server 105 to facilitate such communication. In such embodiments, the NFC interface 115 may be integrated into a communication interface of the server 105 and powered by the server 120. The two-way communication allows the exchange of data so that the various diagnostic and configuration functionalities described herein are enabled. As further shown, the server 105 and the NFC user device 125 may connect to a network 135, as will be discussed below in relation to particular embodiments.

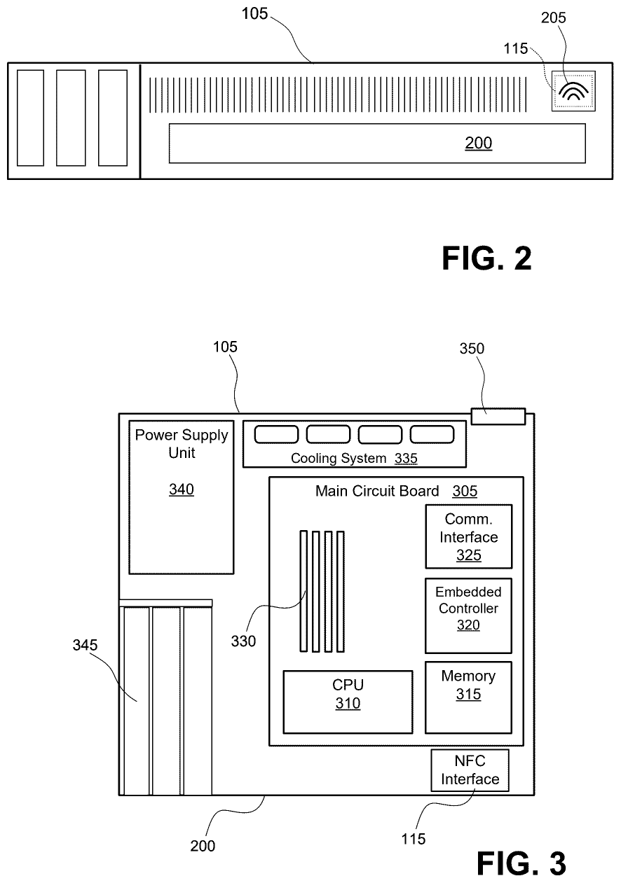

With reference now to FIGS. 2 and 3, an example embodiment of a server 105 is shown having an NFC interface 115 for effectuating near-field communication with a user device. With specific reference to FIG. 2, an illustration of a front panel 200 of a server 105 is shown where the server 105 is configured to enable near-field communication (NFC) according to example embodiments. As described above, the server 105 may include an NFC interface 115, which is embedded within an outer encasement of the server 105. The NFC interface 115 may be disposed near or adjacent to the front panel 200. In accordance with example embodiments, the front panel 200 may include a visual indicator 205 that marks the position of the NFC interface 115. For example, the visual indicator 205 may be aligned with an antenna associated with the NFC interface 115. In this way, the visual indicator 205 marks a target area on the front panel 200, providing a designated spot for a user device to tap in order to initiate a communication session with the NFC interface 115. In accordance with exemplary embodiments, the visual indicator 205 allows users to easily locate the NFC interaction point, thereby facilitating establishing a communication session with the NFC interface 115. In the example provided, the visual indicator 205 is shown as an icon representing an NFC carrier field. Other designs for the visual indicators 205 may be used.

With specific reference now to FIG. 3, a schematic diagram illustrates exemplary internal components of a server 105, which includes an integrated NFC interface 115 according to the present disclosure. The NFC interface 115 of the server 105 may be configured as a component contained within an outer encasement of the server 105. Specifically, as illustrated, the NFC interface 115 may be disposed near or adjacent to the front panel 200 of the server 105.

The server 105 may further include a main circuit board 305, which acts as the foundation for connecting and integrating various components. Though other configurations are also possible, the main circuit board 305 may support one or more central processing units (CPUs) 310, which are responsible for executing instructions and processing data. Adjacent to the CPU 310, a memory 315 may be provided that includes RAM for temporary storage of data and applications currently in use. Servers typically have large amounts of RAM to handle multiple tasks efficiently. The server 105 may include various types of storage devices to hold data permanently, which may include Hard Disk Drives (HDDs) and Solid-State Drives (SSDs). An embedded controller 320 may also be provided. The embedded controller 320 may be configured to manage various internal functions and interfaces with other server components and subsystems. A communication interface 325 may be provided for enabling connectivity with external devices and networks. The communication interface 325 may also connect to the NFC interface 115, allowing the embedded controller 320 to transfer data to the NFC interface 115 and control NFC communication with user devices. This configuration enables interaction between the NFC interface 115 with the other subsystems of the server 105, which may support functionality related to server diagnostics, configuration, data transfer, and device management through an NFC connection established with an NFC user device. Expansion slots 330 may also be provided on the main circuit board 305 to allow for the addition of components.

The internal configuration of the server 105 may further include a cooling system 335, which may include fans and heat sinks designed to dissipate heat. Power to all internal components may be supplied by a power supply unit 340, which converts electrical power to the voltages for use by the server 105. Drive bays 345 may be included to house storage devices like hard drives or solid-state drives, providing the additional storage capacity. Various connectors 350, which may include types such as USB, Ethernet, and power connectors, facilitate the connection of peripheral devices, networks, and power sources.

The server 105 may include other components (not illustrated) necessary or desirable for effectuating desired server functionality. For example, the server 105 may include Network Interface Cards (NICs), which are used to connect the server to a network. The server 105 may include a physical outer encasement or housing that contains all the server components. The housing is typically designed to provide access to the server for maintenance and upgrades. The server 105 may include firmware or Basic Input/Output System (BIOS), which is software embedded in the motherboard that initializes and manages the hardware components during boot-up. The server 105 may include an operating system and other software that manages hardware resources and provides services to applications.

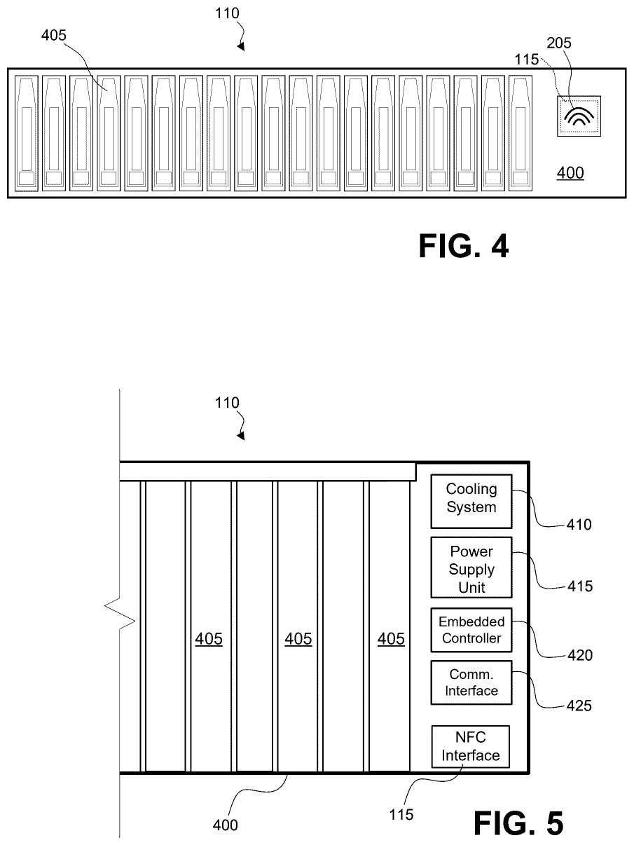

With reference now to FIGS. 4 and 5, an example embodiment of a storage enclosure 110 is shown having an NFC interface 115 for effectuating near-field communication with a user device. With specific reference to FIG. 4, an illustration of a front panel 400 of a storage enclosure 110 is shown where the storage enclosure 110 is configured to enable near-field communication (NFC) according to example embodiments. The storage enclosure 110 may include several drive bays 405 aligned in a row across the front panel 400. The drive bays 405 may be configured to house storage devices like hard drives or solid-state drives, providing the storage capacity for a given scenario. Various connectors (not shown) may also be provided that facilitate the connection of peripheral devices and power sources.

With specific reference now to FIG. 5, a schematic diagram illustrates exemplary internal components of a storage enclosure 110, which includes an integrated NFC interface 115 according to the present disclosure. The NFC interface 115 of the storage enclosure 110 may be configured as a component contained within an outer encasement of the server 105. Specifically, as illustrated, the NFC interface 115 may be disposed near or adjacent to the front panel 400 of the storage enclosure 110.

In accordance with example embodiments, the front panel 400 may include a visual indicator 205 that marks the position of the NFC interface 115, which may be similar to that shown in relation to the server of FIG. 2. That is, the visual indicator 205 may be aligned with an antenna associated with the NFC interface 115 and, thereby, marks a target area on the front panel 400 of the storage enclosure 110. The visual indicator 205 notifies a user of a designated spot for a user device to tap in order to initiate a communication session with the NFC interface 115.

Though other configurations are also possible, the internal configuration of the storage enclosure 110 may further include a cooling system 410, which includes fans and heat sinks designed to dissipate heat. Power may be provided to the internal components of the storage enclosure 110 via a power supply unit 415, which converts electrical power to the voltages usable by the storage enclosure 110. The storage enclosure 110 may further include an embedded controller 420, which manages various internal functions and interfaces with other subsystems of the enclosure. A communication interface 425 enables connectivity with external devices and networks. The communication interface 425 may further connect to the NFC interface 115, allowing the embedded controller 420 to transfer data to the NFC interface 115 and control communication via with user devices. This configuration further enables interaction with the subsystems of the storage enclosure 110, which, as will be seen, supports functionality related to diagnostics, configuration, data transfer, and storage enclosure management through an NFC connection established with an NFC user device.

The storage enclosure 110 may include a physical outer encasement or housing that contains its components and subsystems. The housing is typically designed to provide access to the storage enclosure 110 for maintenance and upgrades. The storage enclosure 110 may include firmware embedded in the motherboard that initializes and manages the hardware components during boot-up. The storage enclosure 110 may include an operating system and other software that manages hardware resources.

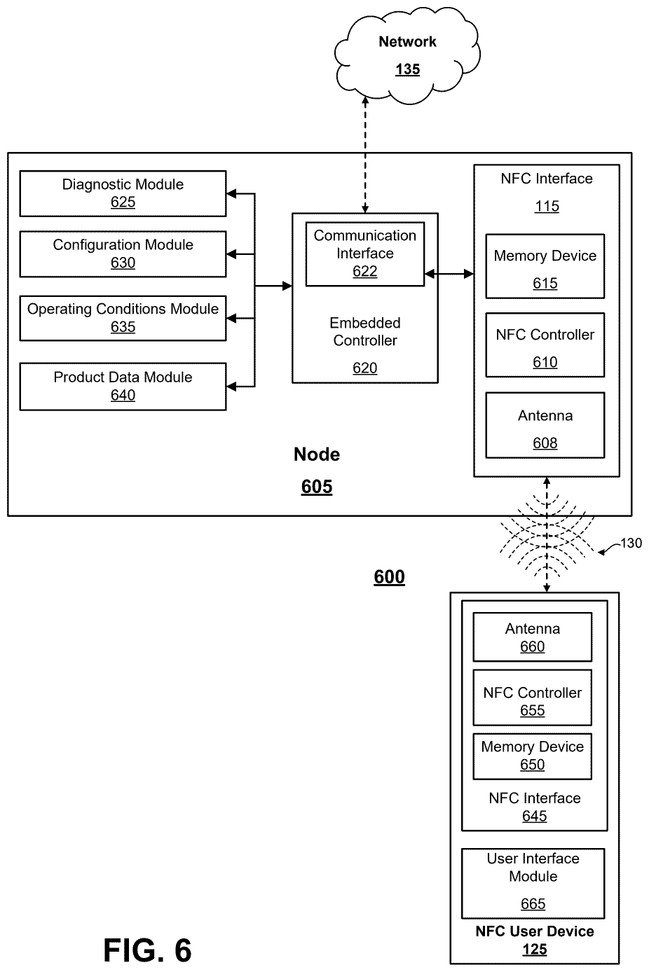

In accordance with exemplary embodiments, FIG. 6 illustrates a block diagram 600 of an example of a network node (or node) 605 in communication with an NFC user device 125 via NFC technology. In this case, exemplary functionality will be discussed in relation to a node, i.e., the node 605, which represents a hardware component in a computer system. In example embodiments, the node 605 may be a computing node, such as the server 105 discussed above. In other embodiments, the node 605 may be a storage node, such as the storage enclosure 110 discussed above. A computing node serves to provide processing power and manages network resources, while a storage node offers scalable data storage capacity. As shown, the node 605 may include an NFC interface 115, which enables wireless communication with an NFC-enabled user device user device 125. The NFC communication between these devices allows for secure data exchange over a short range, facilitating the functionality described herein, including tasks such as diagnostics, configuration, and management related to the node 605.

In example embodiments, the NFC interface 115 within the node 605 may include several subcomponents, including an NFC controller 610, a memory device 615, and an antenna 608. The NFC controller 610 may manage NFC communication protocols and controls the data flow between the node 605 and the NFC user device 125. The memory device 615 may store data transmitted or received during the NFC session. The antenna 608 may be responsible for transmitting and receiving NFC signals. In example embodiments, the NFC interface 115 may connect to the embedded controller 620 via a communication interface 622, facilitating data exchange and coordination of NFC communications.

In example embodiments, the embedded controller 620 is configured to interface with several operational modules that manage operation of the node 605 and control respective different operational areas. In example embodiments, a diagnostic module 625 represents functionality included within the node 605 by which diagnostic information about the node 605 is gathered and recorded. The diagnostic module 625 may monitor operational health and performance of the node 605, for example, detecting errors or faults and recording data related thereto. The diagnostic module 625 may maintain diagnostic data and provide such data to the embedded controller 620 when called upon. In example embodiments, a configuration module 630 allows for the adjustment of system settings and maintains data related thereto. The embedded controller 620 may modify operational parameters via the configuration module 630. In example embodiments, an operating conditions module 635 may monitor and report the environmental and operational conditions of the node 605 and maintain data related thereto. The operating conditions module 635 may receive readings from sensors measuring respective operating conditions in respective subsystems of the node 605. In example embodiments, a product data module 640 may store product-specific information, which can be accessed and managed by the embedded controller 620. The embedded controller 620 is configured to communicate with each module to access data or change operational settings as requested or needed.

The NFC user device 125 may include any type of user device that is enabled for near-field communication. In the example of FIG. 6, the NFC user device 125 is shown as having an NFC interface 645 that is configured similarly to the NFC user device 125 of the node 605 for like function. Other configurations are also possible. The NFC interface 645 of the user device 125 may include an NFC controller 655, a memory device 650, and an antenna 660, which may function in a manner similar to that described above in relation to the NFC interface 115 of the node 605. In general, for example, the NFC controller 655 manages NFC communication protocols and controls the data flow between the NFC user device 125 and the node 605. The memory device 650 stores data transmitted or received during the NFC communication session. The antenna 660 is responsible for transmitting and receiving NFC signals. As discussed below, the user device 125 may include a user interface module 665 that allows the user to interact with the system, providing a means to select and manage NFC communication with the node 605. Through the user interface 665, the user can choose different types of data and operational modules for interaction with the node 605. This interaction enables the user to customize the NFC communication process, selecting specific data to be transmitted or received and adjusting operational settings as requested or needed.

In example embodiments, the user interface module 665 of the NFC user device 125 is configured to facilitate user interaction with the system, providing a means for the user to initiate and manage an NFC communication session with the node 605. For example, via a user interface generated by the user interface module 665, a user may be provided with a menu of selectable options and allowed to select one. As an example, the selectable options may include the respective different types of data collected and maintained by the operational modules described above in relation to the node 605. Thus, for example, in response to establishing an NFC communication session with the node 605, the user interface module 665 may generate a menu on a display of the user device that provides selectable options available to the user. The available options may be tailored for particular types of users and based on authentication of the user. The user then may select one of the options, such as “configuration data,” from the menu, resulting in that request being transmitted via NFC to the node 605. Such menu may be multi-leveled, allowing the user to further select between different categories of configuration data. In response, the node 605 may collect the requested data and provide it to the NFC user device 125 via the NFC communication session established between the user device 125 and the node 605. A similar process may allow a user to change a configuration setting. The user interface may include, for example, a keyboard or keypad, a display (for example, a touch screen display), or other input/output mechanisms.

In regard to the NFC interface 115 provided within the node 605, the antenna 608 may be configured to both transmit and receive radio frequency signals. The antenna 608 may operate on the principle of electromagnetic induction. When the antenna 608 generates an alternating magnetic field, it induces an electric current in the receiving antenna 660 of the user device 125. Modulation of this current enables the exchange of data between the devices, i.e., between the node 605 and the user device 125. In general, NFC antennas are designed for short-range communication, typically within a few centimeters and may function in both passive and active modes. In passive mode, the antenna draws power from the electromagnetic field generated by the other NFC-enabled device. In active mode, the antenna is powered by a power source within the NFC interface and can initiate communication. The antenna may be configured to operate at a standardized frequency of 13.56 MHz, which ensures compatibility and interoperability among various NFC-enabled devices.

The NFC controller 610 of the NFC interface 115 may be configured to manage the NFC communication process. For example, the NFC controller 610 may initiate NFC communication by generating a radio frequency signal via the antenna 608 when an NFC-enabled device is in close proximity or may detect a radio frequency signal generated by an NFC-enabled device, such as user device 125, and respond to it. The NFC controller 610 further may manage the exchange of data between the NFC interface 115 device and a target device, e.g., the NFC user device 125, including encoding and decoding data, ensuring secure transmission, and handling error correction. The NFC controller 610 handles the NFC communication protocols, ensuring compatibility and interoperability with other NFC devices, and manages the NFC Data Exchange Format (NDEF) for structured data exchange. The NFC controller 610 also may ensure secure transactions by, for example, incorporating secure elements, tokens, or SIM cards. For example, in example embodiments, the NFC interface 115 may include a secure element, which is a dedicated chip within the device responsible for storing sensitive information, isolated from the main operating system. In other embodiments, the NFC controller 610 may receive, from the user device 125, an identity token for authenticating the user device 125. The NFC controller 610 may be configured to compare the identity token against records of valid identity tokens, stored locally to the device, to determine whether the identity token is valid. The NFC controller 610 also may provide a user interface for NFC operations. More generally, the NFC controller 610 orchestrates the NFC communication process for a secure and efficient data exchange between devices. In example embodiments, the NFC controller 610 may be an integrated circuit that manages the communication protocol between the antenna and the devices operating system, handling data encryption and transmission.

The memory device 615 of the NFC interface 115 may provide storage capacity to enable several types of functionalities within the NFC interface 115. The memory device 615 may store the data that is transmitted to or received from other NFC-enabled devices, such as NFC user device 125. This data may include any of the information described herein in relation to functionality of example embodiments. The memory device 615 may hold configuration settings that dictate how the NFC interface 115 operates, such as parameters for communication protocols, security settings, and operating modes. For secure transactions, the memory device 615 may store authentication credentials, such as tokens or certificates, which can ensure that only authorized devices can access data or issue commands. The memory device 615 may store the NFC interface's firmware, which controls its operation. This may also include an operating system and other software applications that enables the device to perform tasks like data encoding, decoding, error correction, and other functionality described herein. During communication, the memory device 615 may further act as temporary storage to buffer data being transmitted or received.

The NFC interface 115 may further include a processor (not shown) that interacts with the NFC controller 610 to initiate and manage NFC operations. For example, the processor may represent one or more processors operating in concert, each comprised of a plurality of transistors, logic gates, a clock (for example, oscillator), other circuitry, and the like to facilitate performance of the functionality described herein. In some example embodiments, the processor is configured to execute instructions stored in the memory device 615 or instructions otherwise accessible to the processor. The processor may be configured to operate such that the processor causes the NFC interface 115 to perform various functionalities described herein.

As also indicated, the NFC interface 115 may connect to or be integrated with a communication interface 622 associated with the node 605. The communication interface 622 may be any device or means (for example, circuitry) embodied in hardware, a computer program product, or a combination of hardware and a computer program product that is configured to receive and/or transmit data from/to a network 130, the NFC interface 115, and/or, via the NFC interface 115, the NFC user device 125. The communications interface 620 may be configured to communicate information via any type of wired or wireless connection, and via any type of communications protocol.

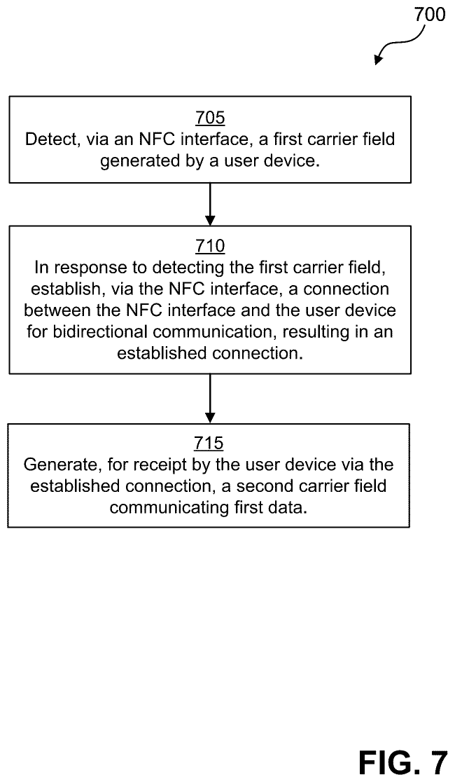

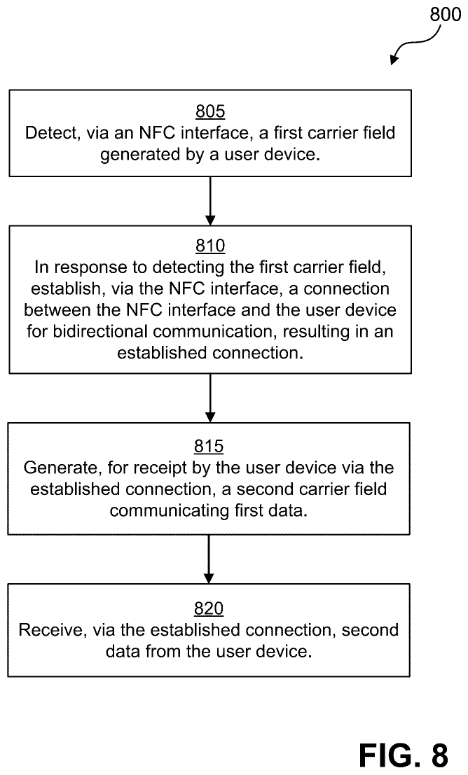

As will be appreciated, the exemplary systems and devices disclosed above—in which devices, such as servers or storage enclosures, are equipped with an integrated NFC interface—support a range of functionality that facilitates efficient servicing and configuring of devices using NFC. Exemplary embodiments enable an embedded controller to collect data about the device, such as diagnostic information, and then communicate that data via NFC to a user device, enabling technicians to quickly assess any present operational issues. Additionally, example embodiments further enable the embedded controller and integrated NFC interface to accept commands from a user device via NFC, so technicians can easily modify configuration settings and implement new modes of operation. With technicians being able to diagnose and rectify problems more efficiently, the downtime for such devices can be minimized while servicing costs are reduced. The integration of the NFC interface with the different types of operational modules supports further functionality facilitating a comprehensive approach to device management and troubleshooting through secure NFC. In accordance with various embodiments of the present disclosure, exemplary methods covering the various functionalities will now be discussed in relation to FIGS. 7 and 8. As will be seen, the discussion related to FIG. 7 is aimed at various embodiments for acquiring data from a device using near-field communication, while the discussion related to FIG. 8 covers various embodiments for both acquiring data from a device as well as configuring the device using near-field communication.

With reference now to FIGS. 7-10, methodologies in accordance with the disclosed subject matter are illustrated. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term “article of manufacture,” as used herein, is intended to encompass a computer program accessible from any computer-readable device, carrier, or media.

With specific reference to FIG. 7, a method 700 is illustrated for acquiring data from a device using near-field communication. In accordance with example embodiments, the device can be configured for use as a computing node or a storage node within a data storage system. In example embodiments, the device may be a discrete unit defined by an outer encasement within which computer executable components are housed. The computer executable components may include both an embedded controller and a near-field communication (NFC) interface. The embedded controller may be configured to interface with operational modules that manage operation of the device and control respective different operational areas of the device. The NFC interface may connect to the embedded controller to facilitate sending and receiving NFC communications.

At 705, the embedded controller is configured to detect, via the NFC interface, a first carrier field generated by a user device.

At 710, the embedded controller is configured to, in response to detecting the first carrier field, establish, via the NFC interface, a connection between the NFC interface and the user device for bidirectional communication, resulting in an established connection.

At 715, the embedded controller is configured to generate, for receipt by the user device via the established connection, a second carrier field communicating data.

In example embodiments, the operational modules may include a diagnostic module configured to perform diagnostic checks to gather operational health data describing an operational health of the device. In relation to such embodiments, the data, which is generated for receipt by the user device, may include the operational health data.

In example embodiments, the device may be configured for use as a computing node, which may include a server having a central processing unit. The operational health data may include a performance characteristic of the central processing unit.

In example embodiments, the device may be configured for use as the storage node. The storage node may be a storage enclosure having a storage capacity defined by disk drives installed therein. The operational health data may include fault data describing a fault detected in a specified disk drive among the disk drives.

In example embodiments, the operational modules comprise a product data module configured to maintain product data describing the device. The product data may include device data describing a make and/or model of the device, and/or technical specifications related to a type of central processing unit or a type of storage. In relation to such embodiments, the data, which is generated for receipt by the user device, may include the product data.

In example embodiments, the operational modules may include an operating conditions module configured to maintain sensor data describing measurements made by sensors disposed within the device that relate to operating conditions of the device. The operating conditions may include a temperature, load, and/or fan speed. In relation to such embodiments, the data, which is generated for receipt by the user device, may include the sensor data.

With specific reference to FIG. 8, a method 800 is illustrated associated with acquiring data from a device and/or configuring the device using near-field communication. In accordance with example embodiments, the device can be configured for use as a computing node or a storage node within a data storage system. In example embodiments, the device may be a discrete unit defined by an outer encasement within which computer executable components are housed. The computer executable components may include both an embedded controller and a near-field communication (NFC) interface. The embedded controller may be configured to interface with operational modules that manage the operation of the device and control respective different operational areas of the device. The NFC interface may connect to the embedded controller to facilitate sending and receiving NFC communications.

At 805, the embedded controller is configured to detect, via the NFC interface, a first carrier field generated by a user device.

At 810, the embedded controller is configured to, in response to detecting the first carrier field, establish, via the NFC interface, a connection between the NFC interface and the user device for bidirectional communication, resulting in an established connection.

At 815, the embedded controller is configured to generate, for receipt by the user device via the established connection, a second carrier field communicating first data.

At 820, the embedded controller is configured to receive, via the established connection, second data from the user device.

In example embodiments, the operational modules further may include a configuration module that is configured to maintain configuration settings data describing configuration settings for the device. In relation to such embodiments, the first data may include the configuration settings data, and the second data may include a command describing an adjustment to the configuration settings. The embedded controller may be further configured to effectuate, via the configuration module, the command to result in the configuration settings being adjusted in accordance with the command.

In example embodiments, the establishing of the connection between the NFC interface and the user device may include authenticating the user device. The authenticating may include, receiving, from the user device, an identity token. The authenticating may further include comparing the identity token against records of valid identity tokens, stored locally to the device, to determine whether the identity token is valid.

In example embodiments, the first data may include menu data usable by the user device to construct a user interface. The user interface may display selectable information categories determined to be accessible to the user device based on the successful authentication. The second data may indicate a selected information category from the selectable information categories. In example embodiments, the embedded controller may be further configured to generate, for receipt by the user device via the established connection, a third carrier field communicating third data. The third data may correspond to the selected information category represented by the second data.

In example embodiments, the outer encasement of the device may form a cuboidal shape facilitating stacking of the device with other devices of the data storage system having the same shape. In example embodiments, the NFC interface may include an antenna disposed adjacent to a front panel of the outer encasement. The front panel may include a visual indicator aligned with the antenna that indicates a target area on the front panel for the user device to tap to initiate a communication session via the NFC interface. In example embodiments, the data storage system may comprise a network-attached storage (NAS) system. In example embodiments, the user device may include a smartphone or a tablet.

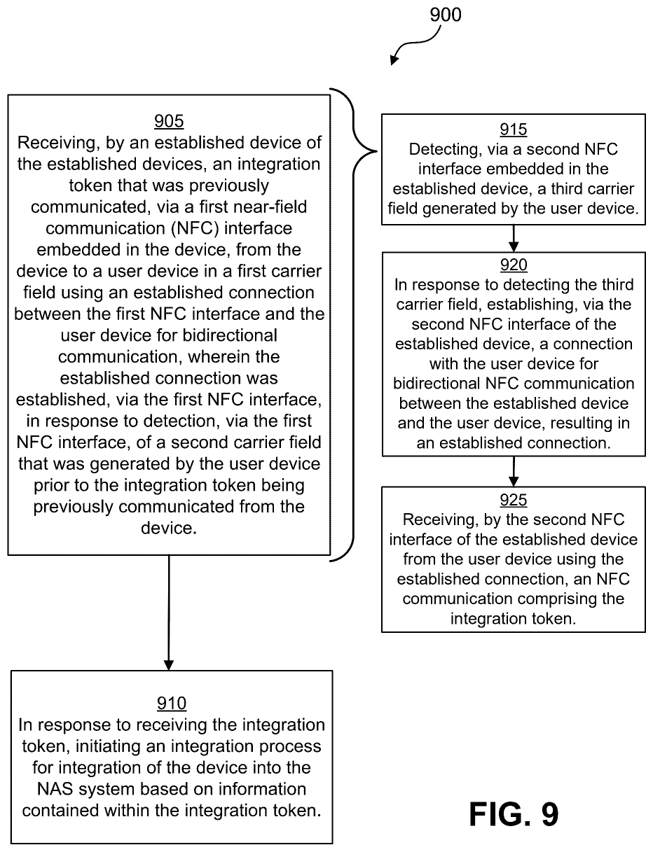

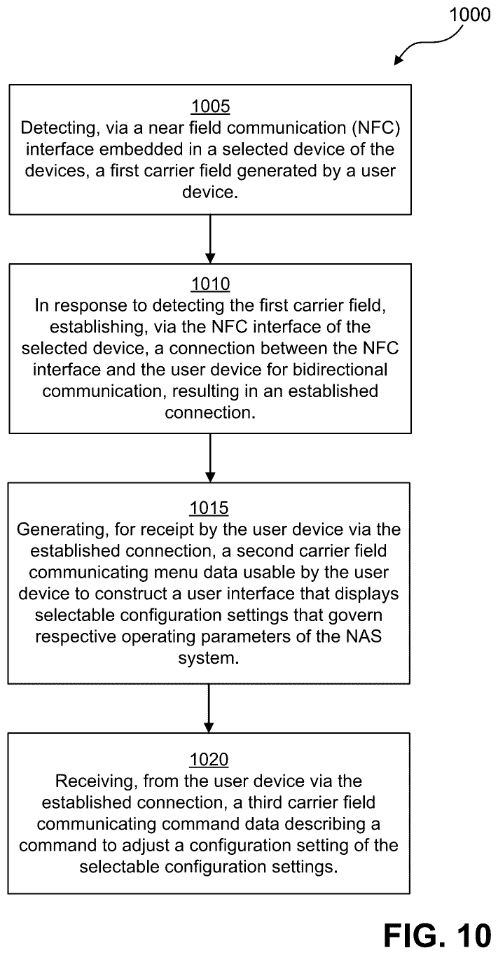

With reference now to FIGS. 9 and 10, alternative embodiments are provided in which the above-disclosed NFC systems and devices facilitate various functionalities related to a cluster of established devices, including adding a device to the cluster and configuring the cluster, respectively.

With reference to FIG. 9, example embodiments of the present disclosure can be used to facilitate the adding of a device to a cluster or network of established devices via NFC. As used herein, the term “established devices” refers to devices that are already functioning in the network. For example, in an exemplary embodiment, an NFC user device may connect to (or tap) an NFC-enabled “unconnected device,” which may be used to refer to the device being added to the network. The unconnected device may be a server or storage enclosure that is configured with an NFC interface as previously disclosed. Once an NFC connection is established, the user device uses the connection to retrieve an integration token from the unconnected device, which is used for authenticating the unconnected device for integration within the network. In example embodiments, this is done by tapping the user device against one of the established devices within the network that is also NFC-enabled (i.e., configured with an NFC interface). Once an NFC connection is established with the established device, the integration token is transferred to the established device (and, thereby, to the cluster or network), which triggers the process of connecting to the unconnected device and adding it to the network.

The term “integration token” refers to a unique, digitally encoded identifier used to authenticate and authorize device for inclusion within a network and facilitate its configuration for function within the network. The integration token may contain a unique identifier for authentication. The integration may contain credentials to verify the identity of the device attempting to join the network. These credentials can be in the form of cryptographic keys, certificates, or other forms of secure digital signatures that prove the device's legitimacy. The integration token also may carry configuration information usable by the device to function within the network. This may include network settings, IP addresses, and other relevant details. By providing this information within the token, the new, unconnected device can be automatically configured to match the network's specifications or requirements, minimizing any manual setup.

In alternative embodiments, the process may proceed in the other direction, where the user device first taps an established device to initiate the process. In this case, the user device first establishes an NFC connection with one of the established devices in the network, which then is used to retrieve an integration token from the established device. The user device then taps the unconnected device and transfers the integration token, which prompts the unconnected device to message the cluster. The message may be via a network connection identified within the integration token or subsequent further NFC communications facilitated by the user device. The message then prompts the cluster to initiate the process of adding the unconnected device to the network. In either case, tapping into the existing cluster or network may involve authentication. This authentication can be achieved either through the integration token or by prompting the user for authentication using various methods, such as a username and password, single-sign-on (SSO), multi-factor authentication (MFA), or other authentication mechanisms.

Referring specifically now to FIG. 9, a method 900 is illustrated for adding or integrating, by a system comprising at least one processor, a device (which refers to the unconnected device in the above examples) into a network-attached storage (NAS) system that includes established devices using near-field communication. As used herein, established devices are devices that are already connected and operational within the NAS system. The device and the established devices each may be configured as either a computing node or storage node within the NAS system.

At 905, the method 900 may include the act of receiving, by an established device of the established devices, an integration token that was previously communicated, via a first near-field communication (NFC) interface embedded in the device, from the device to a user device in a first carrier field using an established connection between the first NFC interface and the user device for bidirectional communication, wherein the established connection was established, via the first NFC interface, in response to detection, via the first NFC interface, of a second carrier field that was generated by the user device prior to the integration token being previously communicated from the device. The receiving of the integration token may further include a subroutine, as indicated by acts 915-925, which is discussed below.

At 910, the method 900 may include the act of, in response to receiving the integration token, initiating an integration process for integration of the device into the NAS system based on information contained within the integration token.

At 915, the subroutine for receiving the integration token includes the act of detecting, via a second NFC interface embedded in the established device, a third carrier field generated by the user device.

At 920, the subroutine for receiving the integration token includes the act of, in response to detecting the third carrier field, establishing, via the second NFC interface of the established device, a connection with the user device for bidirectional NFC communication between the established device and the user device, resulting in an established connection.

At 925, the subroutine for receiving the integration token includes the act of receiving, by the second NFC interface of the established device from the user device using the established connection, an NFC communication comprising the integration token.

In example embodiments, the integration token includes: authentication information that authenticates the device to the NAS system, and integration information that facilitates the integration of the device into the NAS system. The integration information may include a universal resource locator referencing instructions that include configuration settings applicable to the device for the integration of the device into the NAS system. In example embodiments, the configuration settings may include: respective values for the configuration settings corresponding to the integration of the device into the NAS system; and at least one access right specifying at least one action that the device is allowed to perform within the NAS system.

With reference to FIG. 10, example embodiments of the present disclosure facilitate the configuration a cluster or network of devices via NFC with one of the devices within the cluster or network. The devices within the cluster or network each may be a server or storage enclosure that is configured with an NFC interface as previously disclosed. This process may be initiated by an NFC user device connecting to (or tapping) an NFC-enabled device within the cluster or network. The NFC-enabled device may be a server or storage enclosure that is configured with an NFC interface as previously disclosed. Once the user device is authenticated and an NFC connection is established, the user device then may use the connection to configure the cluster via an application on the user device. In example embodiments, the configuration process may further include the use of a web browser of an embedded web server in the cluster. In example embodiments, this method may facilitate providing an initial configuration to a new cluster or network of devices that currently has no configuration settings. Alternatively, this method may facilitate changing the configuration settings of an existing cluster or network of device. In this way, the configuration of a cluster of devices is enabled via NFC between a user device and one of the member devices. The configuration of the cluster can proceed without requiring a serial port to perform initial network access configuration.

Referring specifically now to FIG. 10, a method 1000 is illustrated for configuring, by a system comprising at least one processor, a network-attached storage (NAS) system comprising devices. Each of the devices may be configured as either a computing node or a storage node.

At 1005, the method 1000 may include the act of detecting, via a near-field communication (NFC) interface embedded in a selected device of the devices, a first carrier field generated by a user device.

At 1010, the method 1000 may include the act of, in response to detecting the first carrier field, establishing, via the NFC interface of the selected device, a connection between the NFC interface and the user device for bidirectional communication, resulting in an established connection.

At 1015, the method 1000 may include the act of generating, for receipt by the user device via the established connection, a second carrier field communicating menu data usable by the user device to construct a user interface that displays selectable configuration settings that govern respective operating parameters of the NAS system.

At 1020, the method 1000 may include the act of receiving, from the user device via the established connection, a third carrier field communicating command data describing a command to adjust a configuration setting of the selectable configuration settings.

In example embodiments, the method 100 may further include the act of effectuating the command to result in the configuration settings being adjusted in accordance with the command.

In example embodiments, the act of establishing the connection between the NFC interface of the selected device and the user device may include authenticating the user device. The act of authenticating may include receiving, from the user device, an identity token, and comparing the identity token to records of valid identity tokens, stored within the NAS system, to determine whether the identity token is valid. In example embodiments, the selectable configuration data may be tailored to one or more permissions associated with the identity token.

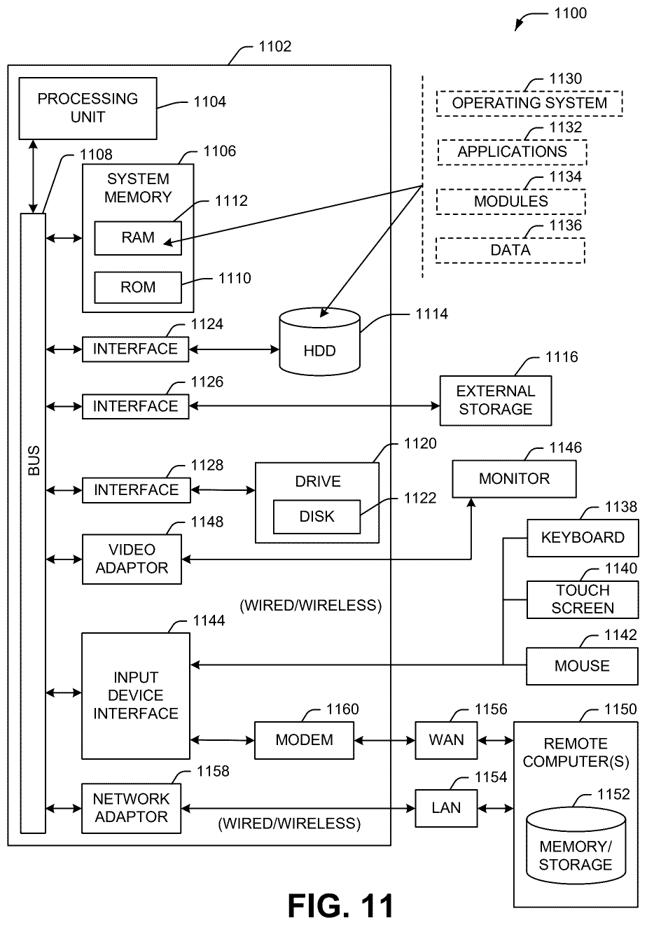

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where example tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various example embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and a drive 1120, e.g., such as a solid state drive, an optical disk drive, which can read or write from a disk 1122, such as a CD-ROM disc, a DVD, a BD, etc. Alternatively, where a solid-state drive is involved, disk 1122 would not be included, unless separate. While the internal HDD 1114 is illustrated as located within the computer 1102, the internal HDD 1114 can also be configured for external use in a suitable chassis (not shown). Additionally, while not shown in environment 1100, a solid-state drive (SSD) could be used in addition to, or in place of, an HDD 1114. The HDD 1114, external storage device(s) 1116 and drive 1120 can be connected to the system bus 1108 by an HDD interface 1124, an external storage interface 1126 and a drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above, such as, but not limited to, a network virtual machine providing one or more examples of storage or processing of information. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

What is claimed is:

1. A device, comprising:
a discrete unit in which computer executable components are housed within an outer encasement, the computer executable components comprising:
an embedded controller configured to interface with operational modules that manage operation of the device and control respective different operational areas of the device; and
a near-field communication (NFC) interface connected with the embedded controller that facilitates sending and receiving NFC communications,
wherein the embedded controller is further configured to:
detect, via the NFC interface, a first carrier field generated by a user device;
in response to detecting the first carrier field, establish, via the NFC interface, a connection between the NFC interface and the user device for bidirectional communication, resulting in an established connection; and
generate, for receipt by the user device via the established connection, a second carrier field communicating data,
wherein the device is configured for use as a computing node of a data storage system or a storage node of the data storage system.

2. The device of claim 1, wherein the operational modules comprise a diagnostic module configured to perform diagnostics checks to gather operational health data describing an operational health of the device, and
wherein the data comprises the operational health data.

3. The device of claim 2, wherein the device is configured for use as the computing node,
wherein the computing node comprises a server comprising at least one central processing unit, and
wherein the operational health data comprises at least one performance characteristic of the at least one central processing unit.

4. The device of claim 2, wherein the device is configured for use as the storage node,
wherein the storage node comprises a storage enclosure having a storage capacity defined by disk drives installed therein, and
wherein the operational health data comprises fault data describing a fault detected in a specified disk drive of the disk drives.

5. The device of claim 1, wherein the operational modules comprise a product data module configured to maintain product data describing the device,
wherein the product data comprises at least device data describing at least one of a make or a model of the device and technical specifications related to at least one of a type of central processing unit or a type of storage, and
wherein the data comprises the product data.

6. The device of claim 1, wherein the operational modules comprise an operating conditions module configured to maintain sensor data describing measurements made by sensors disposed within the device that relate to operating conditions of the device,
wherein the operating conditions comprises at least one of a temperature, a load, or a fan speed, and
wherein the data comprises the sensor data.

7. The device of claim 1, wherein the data comprises first data,
wherein the embedded controller is further configured to:
receive, via the established connection, second data from the user device.

8. The device of claim 7, wherein the operational modules further comprise a configuration module that is configured to maintain configuration settings data describing configuration settings for the device,
wherein the first data comprises the configuration settings data,
wherein the second data comprises a command describing an adjustment to the configuration settings, and
wherein the embedded controller is further configured to:
effectuate, via the configuration module, the command to result in the configuration settings being adjusted in accordance with the command.

9. The device of claim 7, wherein the establishing of the connection between the NFC interface and the user device comprises authenticating the user device, the authenticating comprising:
receiving, from the user device, an identity token; and
comparing the identity token against records of valid identity tokens, stored locally to the device, to determine whether the identity token is valid.

10. The device of claim 9, wherein the first data comprises menu data usable by the user device to construct a user interface that displays selectable information categories determined to be accessible to the user device based on the authenticating being successful, and
wherein the second data indicates a selected information category from the selectable information categories.

11. The device of claim 10, wherein the embedded controller is further configured to:
generate, for receipt by the user device via the established connection, a third carrier field communicating third data, and
wherein the third data corresponds to the selected information category represented by the second data.

12. The device of claim 1, wherein the outer encasement of the device comprises a cuboidal shape facilitating stacking of the device with other devices of the data storage system comprising the cuboidal shape, and
wherein the user device comprises one of a smartphone or a tablet.

13. The device of claim 1, wherein the NFC interface comprises an antenna disposed adjacent to a front panel of the outer encasement, and wherein the front panel comprises a visual indicator aligned with the antenna that indicates a target area on the front panel for the user device to tap for initiation of a communication session via the NFC interface, and
wherein the data storage system comprises a network-attached storage (NAS) system.

14. A method, comprising:
integrating, by a system comprising at least one processor, a device into a network-attached storage (NAS) system comprising established devices, wherein the device and the established devices each comprises one of a respective computing node or a respective storage node, the integrating comprising:
receiving, by an established device of the established devices, an integration token that was previously communicated, via a first near-field communication (NFC) interface embedded in the device, from the device to a user device in a first carrier field using an established connection between the first NFC interface and the user device for bidirectional communication, wherein the established connection was established, via the first NFC interface, in response to detection, via the first NFC interface, of a second carrier field that was generated by the user device prior to the integration token being previously communicated from the device, the receiving comprising:
detecting, via a second NFC interface embedded in the established device, a third carrier field generated by the user device,
in response to detecting the third carrier field, establishing, via the second NFC interface of the established device, a connection with the user device for bidirectional NFC communication between the established device and the user device, resulting in an established connection, and
receiving, by the second NFC interface of the established device from the user device using the established connection, an NFC communication comprising the integration token; and
in response to receiving the integration token, initiating an integration process for integration of the device into the NAS system based on information contained within the integration token.

15. The method of claim 14, wherein the integration token comprises:
authentication information that authenticates the device to the NAS system; and
integration information that facilitates the integration of the device into the NAS system.

16. The method of claim 15, wherein the integration information comprises a universal resource locator referencing instructions that comprise configuration settings applicable to the device for the integration of the device into the NAS system.

17. The method of claim 16, wherein the configuration settings comprise:
respective values for the configuration settings corresponding to the integration of the device into the NAS system; and
at least one access right specifying at least one action that the device is allowed to perform within the NAS system.

18. A method, comprising:
configuring, by a system comprising at least one processor, a network-attached storage (NAS) system comprising devices, wherein each device of the devices comprises one of a respective computing node or a respective storage node, the configuring comprising:
detecting, via a near-field communication (NFC) interface embedded in a selected device of the devices, a first carrier field generated by a user device;
in response to detecting the first carrier field, establishing, via the NFC interface of the selected device, a connection between the NFC interface and the user device for bidirectional communication, resulting in an established connection;
generating, for receipt by the user device via the established connection, a second carrier field communicating menu data usable by the user device to construct a user interface that displays selectable configuration settings that govern respective operating parameters of the NAS system; and
receiving, from the user device via the established connection, a third carrier field communicating command data describing a command to adjust a configuration setting of the selectable configuration settings.

19. The method of claim 18, wherein the configuring further comprises:
effectuating the command to result in the configuration settings being adjusted in accordance with the command.

20. The method of claim 19, wherein the establishing of the connection between the NFC interface of the selected device and the user device comprises authenticating the user device, the authenticating comprising:
receiving, from the user device, an identity token; and
comparing the identity token to records of valid identity tokens, stored within the NAS system, to determine whether the identity token is valid,
wherein the selectable configuration data is tailored to one or more permissions associated with the identity token.
